(19) United States
(12) Patent Application Publication
(10) Pub. No.: US 2014/0368309 A1
(43) Pub. Date: Dec. 18, 2014

(54) CIRCUIT PROTECTION DEVICE

(71) Applicants: G. Todd Dietsch, Park Ridge, IL (US); Olga Spaldon-Stewart, Des Plaines, IL (US); Stephen J. Whitney, Lake Zurch, IL (US)

(72) Inventors: G. Todd Dietsch, Park Ridge, IL (US); Olga Spaldon-Stewart, Des Plaines, IL (US); Stephen J. Whitney, Lake Zurch, IL (US)

(73) Assignee: LITTELFUSE, INC., Chicago, IL (US)

(21) Appl. No.: 13/920,194

(22) Filed: Jun. 18, 2013

(51) Int. Cl. H02H 5/04; H02H 3/20; H02H 7/18; H02H 3/08

(52) U.S. Cl. CPC H02H 5/047; H02H 3/085; H02H 3/20; H02H 7/18
USPC 337/12

(57) ABSTRACT

A circuit protection device, including a conductor connected to first and second terminals and a spring exerting force on the conductor to move the conductor away from the first and/or second terminals when an over-voltage or over-temperature condition occurs within a charging circuit. One or more heat generating resistive elements melts material associated with one or more connection points of the conductor thereby releasing the conductor such that the spring moves the conductor to create an open circuit.

### BACKGROUND OF THE INVENTION

1. Field of the Invention

Embodiments of the invention relate to the field of circuit protection devices. More particularly, the present invention relates to a protection device that generates heat in an over-voltage or over-temperature situation, which melts connections to a conductor, which is then moved by a spring creating an open circuit thereby protecting a power source and related circuitry.

2. Discussion of Related Art

Over-voltage and over-temperature protection devices utilize thermal links, which can melt during an abnormal condition to form an open circuit. These protection devices may be disposed between, for example, a charger and a plurality of rechargeable battery cells (e.g. Li ion batteries). When a voltage that is larger than the threshold voltage is applied to the sensing and trigger circuitry, current flows through heat generating members causing one of more thermal links to melt. Once the links are melted, an open circuit is created which prevents the over-voltage condition from damaging the battery cells. In another type of protection device, thermal cut-off functionality is used to protect the power source, e.g., battery cells. When the temperature of the cells exceeds a particular threshold level, one or more thermal links melt creating an open circuit thereby separating the charging device from the battery cells. However, the thermal coupling between the cells where the over-temperature condition exists and the thermal links may not be sufficient to ensure adequate response time, resulting in a thermal run-away condition.

### SUMMARY OF THE INVENTION

Accordingly, there is a need to provide a protection device configured to result in a sufficiently fast response to protect the battery cells. Exemplary embodiments of the present invention are directed to a protection device disposed between a charger and a one or more battery cells to be charged. Such an exemplary protection device may include a conducting layer having a first terminal and a second terminal disposed on a substrate. A conductor may be disposed on the substrate to electrically connect the first terminal and the second terminal in order to create a closed circuit between the first terminal and the second terminal. Additionally, a low melting material may be disposed between the conductor and the first terminal and between the conductor and the second terminal to hold the conductor in place. A resistive element may be disposed on the substrate positioned to heat the low melting material during an abnormal circuit condition. A spring may be disposed on the substrate and biased to displace the conductor chip and create an open circuit between the first terminal and the second terminal during the abnormal circuit condition when the resistive element heats the low melting material.

### BRIEF DESCRIPTION OF THE DRAWINGS

FIGS. 1A-1P illustrate layers of a protection device in accordance with an embodiment of the present disclosure.

FIG. 2 illustrates a bottom plan view of an exemplary cover of a protection device in accordance with an embodiment of the present disclosure.

### DESCRIPTION OF EMBODIMENTS

The present invention will now be described more fully hereinafter with reference to the accompanying drawings, in which preferred embodiments of the invention are shown. This invention, however, may be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout.

In the following description and/or claims, the terms “on,” “overlying,” “disposed on” and “over” may be used in the following description and claims. “On,” “overlying,” “disposed on” and “over” may be used to indicate that two or more elements are in direct physical contact with each other. However, “on,”, “overlying,” “disposed on,” and over, may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

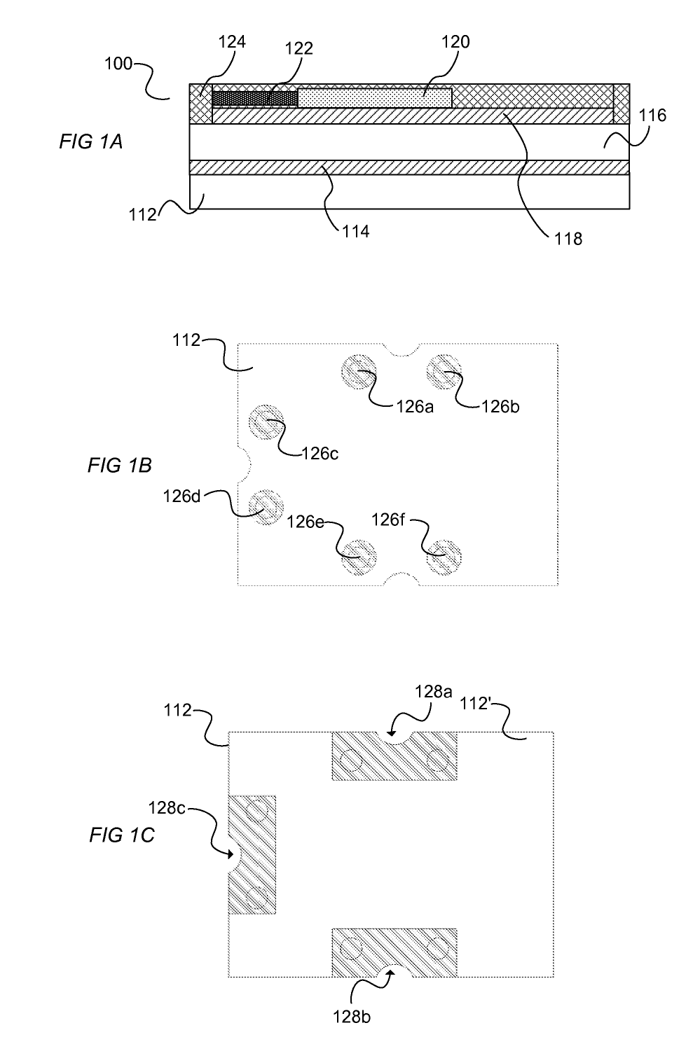

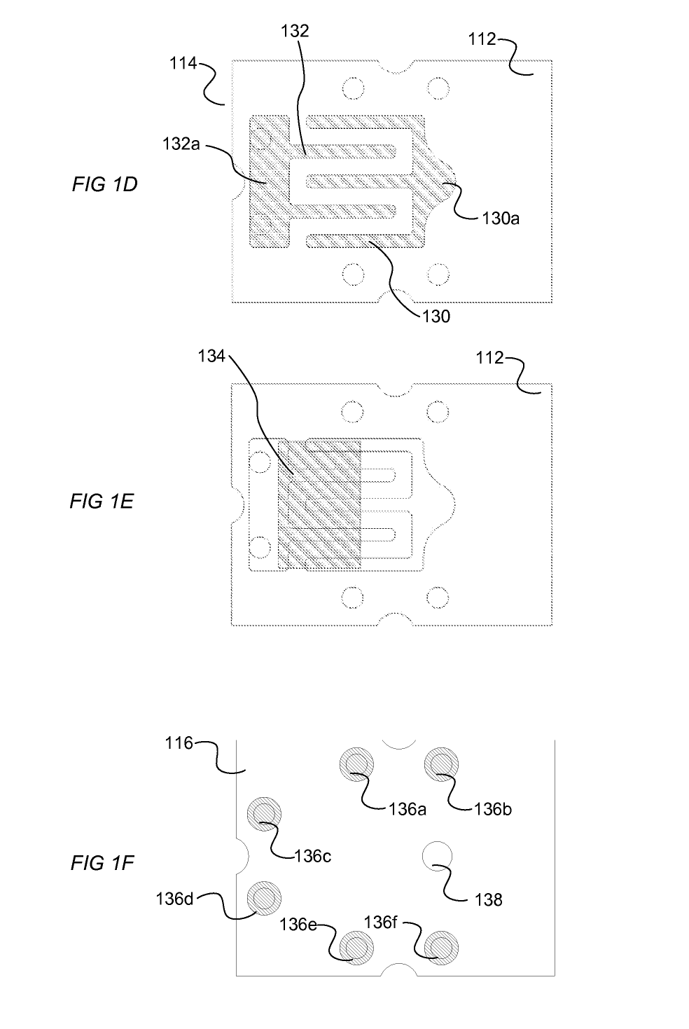

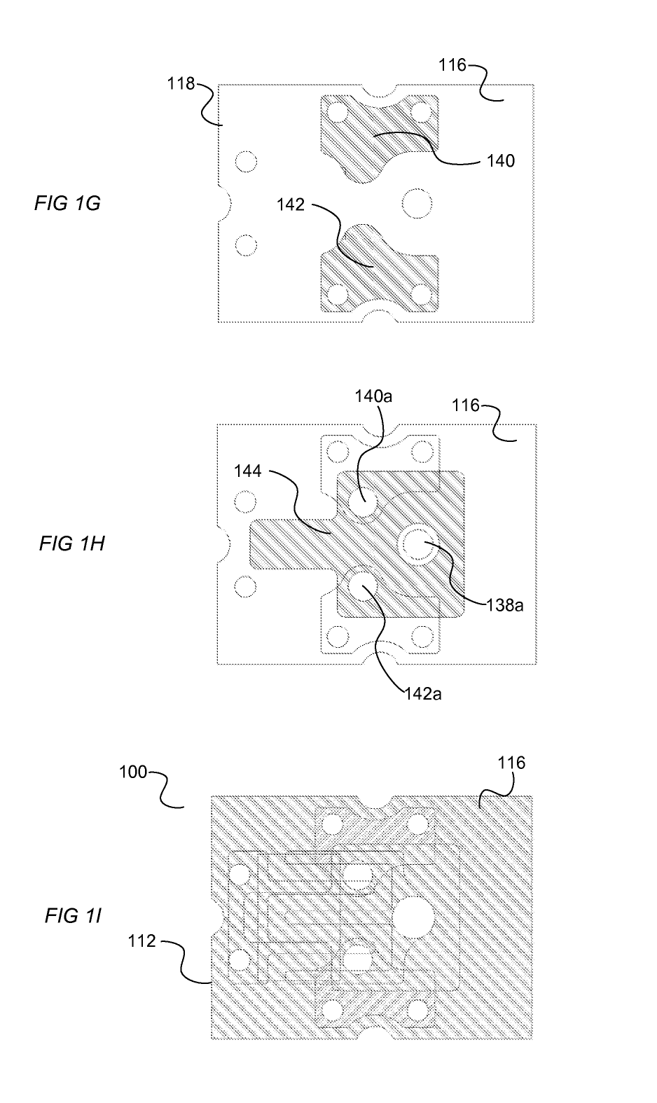

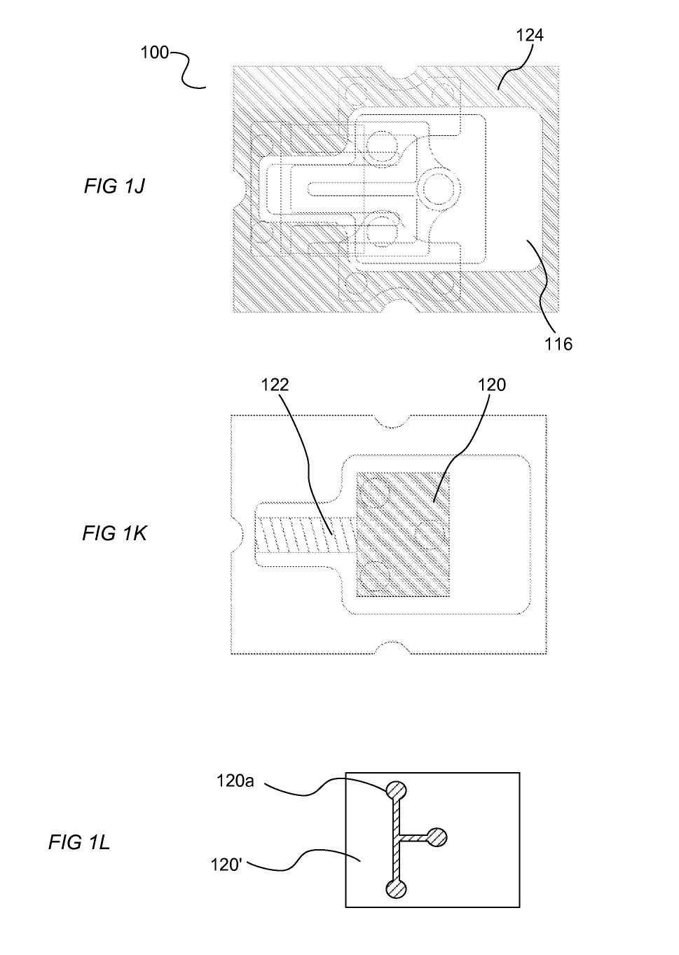

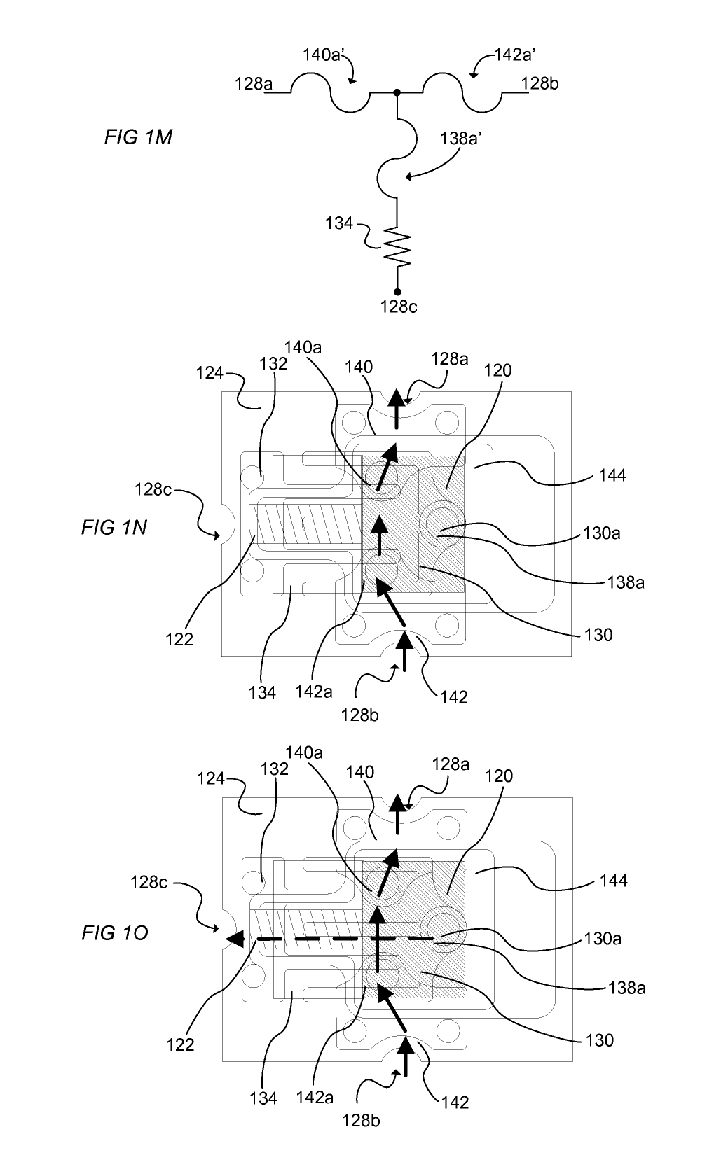

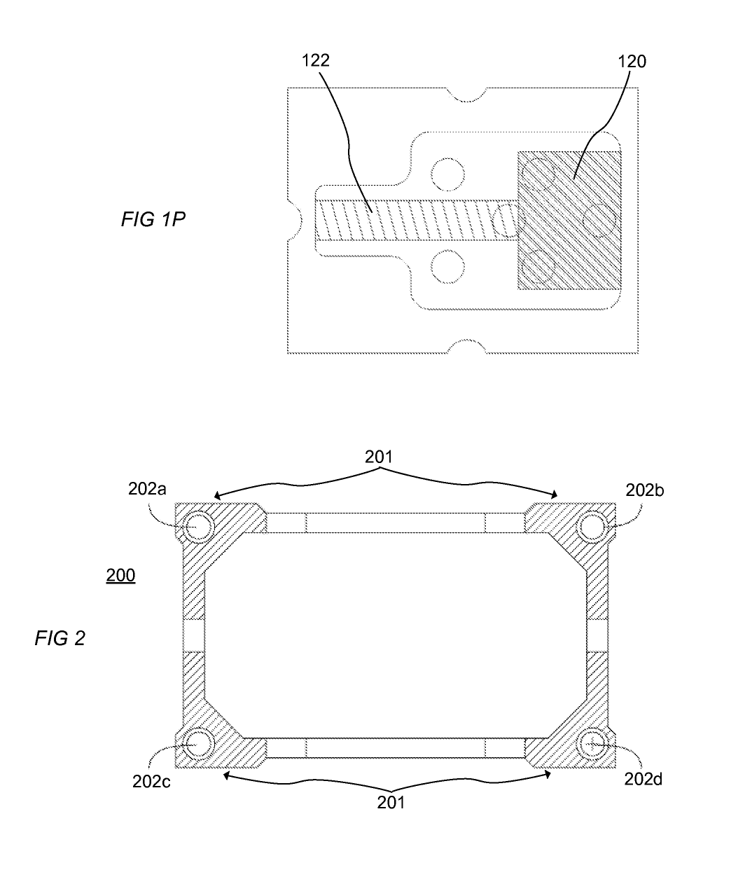

FIGS. 1A-1K illustrate a circuit protection device 100 in accordance with at least some examples of the present disclosure. FIG. 1A illustrates a side-view of circuit protection device 100, which is defined by first and second substrates 112 and 116; having layers 114 and 118 deposited thereon. First and second substrates 112 and 116 are affixed (e.g., laminated, glued, soldered, epoxied, or the like) together to form circuit protection device 100 as depicted. Additionally, circuit protection device 100 includes conductor chip 120, disposed on layer 118 with spring 122 disposed between conductor chip 120 and perimeter wall 124. In some examples, perimeter wall 124 may surround the entire device. However, FIG. 1A shows the perimeter wall 124 on only three sides so that the layer 118, conductor chip 120 and spring 122, which is located inside perimeter wall 124 may be visible in the figure. Operation of the circuit protection device 100 and well as details about first and second substrates 112 and 116 and corresponding layers 114 and 118 will be described below.

FIG. 1B illustrates first substrate 112 having filled vias 126a-126f disposed therein. FIG. 1C depicts the underside 112′ of first substrate 112. As depicted, terminals 128a-128c are formed by covering filled vias 126a-126f with a conductive material. In general, terminals 128a-128c may be formed from any material that conducts electricity. In some examples, terminals 128a-128c are formed by printing leach resistant silver paste onto the underside 112′ of first substrate 112. First terminal 128a and second terminal 128b are used to connect the circuit protection device 100 between a source of charge and a device to be protected, such as, for example, between a charging source and one or more battery cells. Third terminal 128c provides an electrical connection to a control circuit (e.g., sensing circuit and transistor) that may provide an over-voltage or over-temperature signal to circuit protection device 100.

FIG. 1D illustrates layer 114 of the circuit protection device 100 having first metalized conducting path 130 and second metalized conducting path 132 disposed on first substrate 112. First metalized conducting paths 130 and 132, have pads 130a and 132a, respectively. As depicted, pad 132a is disposed over filled vias 126c and 126d, which makes electrical connection between terminal 128c and second metalized conducting path 132. The purpose of pad 130a is described below.

FIG. 1E illustrates the circuit protection device 100 having resistive element 134 disposed on and between metalized conducting paths 130 and 132. With some embodiments, the geometry of the resistive element 134 may be modified to provide robustness to the voltage applied thereto. These geometries are intended to provide heat to the solder pads 140a, 142a, and 138a, as described in more detail below.

FIG. 1F illustrates second substrate 116 having filled vias 136a-136f and through-hole via 138 disposed therein. FIG. 1G illustrates layer 118 of the circuit protection device 100 having first conducting pad 140 and second conducting pad 142 disposed on second substrate 116. As depicted, first conducting pad 140 is disposed over and on filled vias 136a and 136b, while second conducting pad 142 is disposed over and on filled vias 136e and 136f.

FIG. 1H illustrates dielectric layer 144 disposed on second substrate 116 which partially covers first conducting pad 140, second conducting pad 142 and through-hole via 138. Openings are formed through dielectric layer 144 to provide a connection means to a first solder pad 140a on first conducting pad 140, a second solder pad 142a on second conducting pad 142 and a solder pad 138a on and through, through-hole via 138. Dielectric layer 144 may be, for example, a glass or a ceramic material having electrical resistivity sufficiently high enough to act as a dielectric, in order to substantially suppress the conduction of electric current, as such, acting as a solder mask to the underlying and or adjacent components. In some example, the dielectric layer 144 may be formed from ceramic and/or glass material (e.g., powder) and a suitable organic binder. This composition is sometimes referred to as “green tape.” The green tape may be laminated to second substrate 116 and later fired at high temperature, resulting in a rigid ceramic layer that is bonded to second substrate 116. Additionally, dielectric layer 144 may have a desired thermal conductivity to allow heat generated by the resistive element 134 to pass therethrough.

FIG. 1I illustrates second substrate 116 laminated onto first substrate 112 such that filled-vias 126a-126f are substantially aligned with and provide electrical connection to filled vias 136a-136f. Furthermore, through-hole via 138 is substantially aligned with pad 130a. Accordingly, first terminal 128a is electrically connected to first conducting pad 140 and first solder pad 140a through filled-vias 126a-126b and 136a-136b. Similarly, second terminal 128b is electrically connected to second conducting pad 142 and second solder pad 142a through filled-vias 126e-126f and 136e-136f.

FIG. 1J illustrates perimeter wall 124, laminated onto second substrate 116. As described above, perimeter wall 124 has walls on all sides of the circuit protection device 100. In some embodiments, perimeter wall 124 may be formed from substrate material, such as, for example, a green tape ceramic material as described above. Perimeter wall 124 may then be laminated onto second substrate 116 and fired at high temperature to bond the two together. In some embodiments, the perimeter wall 124 may be formed by printing, or building up, multiple layers onto second substrate 116.

FIG. 1K illustrates spring 122 and conductor chip 120. Conductor chip 120 is disposed over solder pads 140a, 142a and 138a. Spring 122 is disposed between conductor chip 120 and perimeter wall 124. Conductor chip 120 may be made from any material, which can conduct current and is affixed to the circuit protection device 100 via the low melt solder, to solder pads 140a, 142a and 138a. In particular, conductor chip 120 may be made from a ceramic material with a conductor such as silver, copper, etc., disposed on its underside in order to form an electrical connection between solder pads 140a, 142a and 138a. The spring 122 may be made from, for example, high carbon steel plated with silver, a shape memory alloy material, or similar conducting material and may, of course, have alternative configurations. Alternatively, the spring 122 may be made from material that is resistive to the conducting of electrical current, such as, for example, an elastomeric material. Additionally, the spring 122 may be round, square, or have other configurations. In general, the spring 122 may be biased to push conductor chip 120 away from solder pads 140a and 142a during an abnormal circuit condition, as described below. A plastic cover (as shown in FIG. 2) may be disposed over the circuit protection device 100 and glued to perimeter wall 124.

FIG. 1L illustrates the underside 120′ of conductor chip 120 on which a conductor 120a is disposed. As noted above, conductor 120a forms an electrical connection between connecting pads 140, 142 and through-hole via 138.

FIG. 1M is a schematic view of circuit protection device 100 including resistive element 134, low melt solder material 140a′, 142a′ and 138a′ and first terminal 128a, second terminal 128b and third terminal 128c. The geometry of the solder pads 140a, 142a and/or 138a may be modified to increase the surface area if more solder is needed to retain conductor chip 120 in position with spring 122.

FIG. 1N is a plan view of the various layers of the circuit protection device 100 shown in shadow disposed on first substrate 112 and second substrate 116 and the associated current flow in a normal conducting situation. During normal operation, current flows (as indicated by the solid arrows) from second terminal 128b to first terminal 128a through the electrical conductive layers. In particular, current flows from second terminal 128b to second conducting pad 142 through filled-vias 126c, 126d, 136c and 136d, from second conducting pad 142 to first conducting pad 140 though conductor 120a, which is disposed on underside 120′ of conductor chip 120, and from conducting pad 140 to first terminal 128a through filled vias 126a, 126b, 136a and 136c.

As shown in FIG. 1O, when an over-voltage or over-temperature situation is detected, a control circuit (not shown) connected to third terminal 128c closes the circuit and draws current from the conductor chip 120 via through-hole via 138. This current (indicated by the dashed arrows) flows from first metalized conducting path 130 to second metalized conducting path 132 through resistive element 134, which produces heat and melts the solder materials 140a′, 142a′ and 138a′. The solder material used may include flux which prevents oxidation of the surface of the solder when it melts, which otherwise might result in smearing or dragging of the solder during spring operation. The melting of the solder joints frees the conductor chip 120 and the spring 122 pushes the conductor away from the solder pads 140a and 142a. This creates an open circuit between terminals 128a and 128b. As such, during an abnormal circuit conditions, an open circuit is created between the source of charge and the device to be protected.

FIG. 1P illustrates the spring 122 and the conductor chip 120 after the abnormal circuit condition described above has occurred and the solder materials 140a′, 142a′ and 138a′ have melted from the heating of resistive element 134. As depicted, the conductor chip 120 has been moved away from the solder pads 140a and 142a by the spring 122. In this manner, the circuit protection device 100 utilizes a mechanical means (e.g., spring 122) to provide a positive disconnection of the circuit. In contrast, prior devices rely on the melting of a conductive element to produce an open circuit which, as noted above, may lead to incomplete disconnection between the terminals, may create excessive unwanted heat within the device and/or may produce unwanted leakage current between the terminals.

FIG. 2 illustrates an exemplary embodiment of a cover 200 described with reference to FIG. 1. Cover 200 is disposed over circuit protection device 100, and adhered to the perimeter wall 124. Typically, cover 200 is bonded to the respective device using an epoxy, but alternative adhesives or bonding methods may be used. Cover 200 includes portions 201 which provide added surface areas around cover 200 to allow for improved bond strength with the epoxy. In addition, portions 201 may have a roughened or textured surface to further improve bond strength with the epoxy. Through holes 202a-202d may be disposed proximate respective portions 201. These holes may be tapered and used to receive epoxy or other adhesive and act as a “locking” feature for cover 200 on the respective substrates. In addition, the through holes 202a-202d may also be disposed at various locations on cover 200. By way of example, by using the combination of portions 201 and through holes 202, cover 200 is able to withstand a pull force up to about 5.8 lbs as compared to a typical industry standard of about 1.12 lbs.

While the present invention has been disclosed with reference to certain embodiments, numerous modifications, alterations and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. A circuit protection device comprising:
a substrate;
a conducting layer disposed on said substrate, said conducting layer having a first terminal and a second terminal;
a conductor disposed on said substrate, said conductor electrically connecting said first terminal and said second terminal creating a closed circuit between said first terminal and said second terminal during a normal operating condition;
a low melting material disposed between said conductor and said first terminal and between said conductor and said second terminal;
a resistive element disposed on said substrate; and
a spring disposed on said substrate, said spring biased to displace said conductor during an abnormal circuit condition when said resistive element heats said low melting material creating an open circuit between said first terminal and said second terminal.

2. The circuit protection device of claim 1, wherein said substrate includes a first substrate and a second substrate having a plurality of filled-vias disposed therein.

3. The circuit protection device of claim 2, wherein said first terminal is disposed on a first side of said first substrate in electrical connection with at least a first one of said plurality of filled-vias disposed in said first substrate, and said second terminal is disposed on said first side of said first substrate in electrical connection with at least a second one of said plurality of filled-vias disposed in said first substrate.

4. The circuit protection device of claim 3, wherein said conducting layer is disposed on said second substrate.

5. The circuit protection device of claim 4, wherein said conducting layer comprises a first conducting pad disposed on said second substrate in electrical connection with at least a first one of said plurality of filled-vias disposed in said second substrate, and a second conducting pad disposed on said second substrate in electrical connection with at least a second one of said plurality of filled-vias disposed in said second substrate.

6. The circuit protection device of claim 5, further comprising a dielectric layer disposed on said second substrate, said dielectric layer partially covering said first and second conducting pads.

7. The circuit protection device of claim 6, wherein said conducting layer further comprises a metalized conducting path disposed on a second side of said first substrate.

8. The circuit protection device of claim 7, further comprising a third terminal disposed on said first side of said first substrate in electrical connection with said metalized conducting path through at least one of said plurality of filled-vias disposed in said first substrate.

9. The circuit protection device of claim 8, wherein said resistive element is disposed on said second side of said first substrate partially covering said metalized conducting path.

10. The circuit protection device of claim 9, wherein said open circuit occurs when said resistive element heats said low melting material, and said spring displaces said conductor away from at least one of said first and second conducting pads to create an open circuit between said first and second terminals.

11. The circuit protection device of claim 10, wherein said second substrate is laminated onto said first substrate such that said filled-vias in said first substrate substantially align with said filled-vias in said second substrate.

12. The circuit protection device of claim 8, wherein said conductor is electrically connected to said metalized conducting path through a through-hole via disposed in said second substrate.

13. The circuit protection device of claim 8, wherein said abnormal circuit condition includes said third terminal drawing current from said first and second terminals through said resistive element.

14. The circuit protection device of claim 1, wherein said abnormal circuit condition includes one or more of an over voltage condition between said first and second terminals, an over current condition between said first and second terminals, or an over temperature condition.

15. The circuit protection device of claim 1, wherein said spring is biased to push said conductor during an abnormal circuit condition.

16. The circuit protection device of claim 1, wherein said spring is biased to pull said conductor during an abnormal circuit condition.

17. The circuit protection device of claim 1, wherein said resistive element is a first resistive element, said device further comprising a second resistive element disposed on said second side of said first substrate partially covering said metalized conducting path.

18. The circuit protection device of claim 1, further comprising a cover disposed over the conducting device and attached to said substrate.

19. The circuit protection device of claim 16 wherein the cover includes at least one extended portion configured to increase the surface area of the cover for attachment to the substrate.

20. A circuit protection device comprising:
a substrate for disposing one or more components of the circuit protection device onto;
a conducting layer for conducting electrical current disposed on said substrate, said conducting layer having a first terminal and a second terminal for electrically connecting said circuit protection device to a battery and a source of charging said battery;
a conductor for electrically connecting said first terminal and said second terminal creating a closed circuit therebetween during a normal operating condition disposed on said substrate;
a low melting material for retaining said conducting layer in place during said normal operating condition disposed between said conductor and said first terminal and between said conductor and said second terminal;
a resistive element for heating said low melting material during an abnormal circuit condition; and
a spring for displacing said conductor creating an open circuit between said first terminal and said second terminal during said abnormal circuit condition.
